(19) United States
(12) Patent Application Publication
(10) Pub. No.: US 2017/0349979 A1
(43) Pub. Date: Dec. 7, 2017

(54) ALUMINUM ALLOY SHEET

(71) Applicant: Kabushiki Kaisha Kobe Seiko Sho (Kobe Steel, Ltd.), Kobe-shi (JP)

(72) Inventors: Takahiro OZAWA, Hyogo (JP); Akihiko TATSUMI, Hyogo (JP); Satoru TAKADA, Hyogo (JP)

(73) Assignee: Kabushiki Kaisha Kobe Seiko Sho (Kobe Steel, Ltd.), Kobe-shi (JP)

(21) Appl. No.: 15/506,609

(22) PCT Filed: Aug. 27, 2015
(86) PCT No.: PCT/JP2015/074298

§ 371 Date: Feb. 24, 2017

(30) Foreign Application Priority Data
Aug. 27, 2014 (JP) 2014-173276

(51) Int. Cl. C22C 21/02; C22F 1/047; C22C 21/06; C22C 28/00; C22C 21/08; C22F 1/05; C22F 1/043

(52) U.S. Cl. CPC C22C 21/02; C22F 1/05; C22F 1/047; C22F 1/043; C22C 28/00; C22C 21/08; C22C 21/06; C01P 2004/61; C01P 2004/03; C01P 2002/70

(57) ABSTRACT

The present invention pertains to an Al—Mg—Si-based aluminum alloy plate comprising, by mass, 0.20-1.50% of Mg, 0.30-2.00% of Si, and 0.005-0.500% of Sn, the balance being Al and unavoidable impurities, wherein the aluminum alloy plate is characterized in having a structure in which, from among all crystallized substances having a circle-equivalent diameter within the range of 0.3-20 μm as measured using a 500×-magnification SEM, crystallized substances containing Sn identified by an X-ray spectrometer have an average number density in the range of 10 per mm² to 2,000 per mm², the proportion of the aforementioned average number density of the crystallized substances containing Sn in relation to the average number density of all crystallized substances having the circle-equivalent diameter being within the range of 0.3-20 μm is 70% or above. With this aluminum alloy plate, it is possible to improve filiform corrosion resistance without inhibiting moldability or BH properties after room-temperature aging.

### TECHNICAL FIELD

The present invention relates to an aluminum alloy sheet, and particularly to an Al—Mg—Si aluminum alloy sheet having excellent filiform corrosion resistance. The aluminum alloy sheet intended in the present invention is a rolled sheet such as a hot rolled sheet or a cold rolled sheet, and means an aluminum alloy sheet after undergoing refining such as a solution treatment and a quenching treatment and before undergoing a baking hardening treatment. Furthermore, aluminum is sometimes referred to as Al in the following description.

### BACKGROUND ART

In recent years, from the consideration to global environment, social needs in weight reduction to vehicles such as automobiles are increasing. To respond to the needs, a lightweight aluminum alloy material having excellent formability and baking hardenability is increasingly used as a material of large-sized body panel structures (outer panel, inner panel and the like) for automobiles, a reinforcing member and the like in place of a steel material such as a steel sheet.

For the purpose of thickness reduction, an Al—Mg—Si aluminum alloy sheet of AA or JIS 6000 series (hereinafter simply referred to as 6000 series) is used as a high strength aluminum alloy in automobile members such as those panel structures.

The 6000 series aluminum alloy sheet has the advantage of having excellent BH responses, but has the problem that the aluminum alloy sheet has room temperature aging property, and formability into a panel, particularly bending workability (hem workability), is deteriorated by the fact that age hardening occurs by maintaining at room temperature after a solution/quenching treatment, thereby increasing strength. Furthermore, in the case where the room temperature aging is large, the following problems occur: BH responses are deteriorated, and yield strength is not improved up to strength required as a panel depending on heating during an artificial aging (hardening) treatment at relatively low temperature such as a baking treatment of a panel after forming.

As one of metallurgical measures to the problem, a method of positively adding Sn to a 6000 series aluminum alloy sheet, thereby improving suppression of room temperature aging and improvement of BH responses is proposed. For example, Patent Document 1 proposes a method of adding an appropriate amount of Sn and then performing pre-aging after a solution treatment, thereby having both of suppression of room temperature aging and BH responses. Furthermore, Patent Document 2 proposes a method of adding Sn and Cu that improves formability to a 6000 series aluminum alloy sheet, and improving formability, a baking property and corrosion resistance.

### PRIOR ART DOCUMENTS

### Patent Document

Patent Document 1: JP H09-249950 A

Patent Document 2: JP H10-226894 A

### SUMMARY OF THE INVENTION

### Technical Problem

However, those conventional Al—Si—Mg aluminum alloy sheets having Sn positively added thereto have a problem that a filiform corrosion resistance should be further improved.

That is, a so-called panel for outer use such as the above-mentioned automobile outer panel is used after painting in many cases, but is exposed to corrosive environment (corrosive environment under coating film) such as sea water or salt water as running environment of automobiles. For this reason, there is a problem that filament-like rust called filiform rust starting from precipitates or inclusions is generated on a surface of an aluminum alloy sheet under a coating film, grows and causes deterioration of strength of a member and poor appearance.

For this reason, in the case where an Al—Mg—Si aluminum alloy sheet having Sn added thereto is used in a so-called panel for outer use such as the above-mentioned automobile outer panel, the alloy sheet is required to have filiform corrosion resistance as a corrosion resistance to such filiform rust.

Various improvement technologies in component, structure and the like at a base metal for improving filiform corrosion resistance have conventionally been proposed in the Al—Mg—Si aluminum alloy sheet. However, metallurgical behavior of an Al—Mg—Si aluminum alloy sheet having Sn added thereto has a different point as compared with that of an Al—Mg—Si aluminum alloy sheet to which Sn is not added, and it was not clear as to whether or not the above-described conventional improvement technologies of a base metal are effective. Furthermore, the problem of improving filiform corrosion resistance was not clearly recognized even in the Al—Mg—Si aluminum alloy sheet having Sn positively added thereto.

Therefore, in order to use an Al—Mg—Si aluminum alloy sheet having Sn added thereto in a panel for outer use such as the above-mentioned automobile outer panel, as a problem thereof, its filiform corrosion resistance should be improved.

The present invention has been made to solve the problem, and has an object to provide a Sn-added Al—Mg—Si aluminum alloy sheet having improved filiform corrosion resistance as a panel for outer use such as an automobile outer panel.

### Technical Solution

The summary of the present invention for an aluminum alloy sheet to achieve the object(s) is as follows. An Al—Mg—Si aluminum alloy sheet includes: in mass %, Mg: 010 to 1.50%; Si: 0.30 to 2.00%; and Sn: 0.005 to 0.500%; with the remainder being Al and unavoidable impurities, and as a structure of the aluminum alloy sheet, in all crystallized substances having an equivalent circle diameter of 0.3 to 20 μm when measured with SEM of 500 magnifications, an average number density of crystallized substances containing Sn identified by an X-ray spectrometer is 10 numbers/mm² to 2000 numbers/mm², and a proportion of the average number density of the crystallized substances containing Sn to an average number density of all crystallized substances having the equivalent circle diameter of 0.3 to 20 μm is 70% or more.

### Advantageous Effects of Invention

The present inventors studied the relationship between addition of Sn and filiform corrosion resistance. As a result, they have found that in a structure of an Al—Mg—Si aluminum alloy sheet, the following peculiar phenomenon occurs: Sn added enters crystallized substances under certain manufacturing conditions, and the crystallized substances are made to have a composition containing Sn, thereby being difficult to become a starting point of filiform rust.

The crystallized substances used herein are Al—Fe intermetallic compound, Al—Fe—Mn intermetallic compound, Al—Fe—Si intermetallic compound and Al—Fe—Mn—Si intermetallic compound, which are formed during casting and solidification of an alloy, and mean intermetallic compounds having relatively large equivalent circle diameter of submicron meters to several ten μm.

When those crystallized substances are present in an aluminum alloy, those are electrochemical potentially more noble than the surrounding aluminum and act as a so-called cathodic site. Therefore, aluminum matrix around those crystallized substances (cathodic site) becomes the state that corrosion is very easy to progress. The corrosion phenomenon appears as filiform rust (rust extending in filament shape) in the state that a surface of an aluminum alloy sheet (panel) is covered with a resin coating film as in the above-mentioned automobile panel.

In this regard, when the crystallized substances have a composition containing Sn, electrochemical potential difference to the surrounding aluminum becomes small, and as a result, the crystallized substances become difficult to act as a cathodic site, thereby being difficult to become a starting point of filiform rust. The mechanism of improving filiform corrosion resistance in the present invention has the great characteristic that it is possible to improve filiform corrosion resistance without decreasing the number of crystallized substances necessary for ensuring mechanical properties such as strength of an aluminum alloy sheet.

For this reason, in the present invention, filiform corrosion resistance can be improved without deteriorating mechanical properties such as strength of an Al—Mg—Si aluminum alloy sheet, and this enables or promotes an Al—Mg—Si aluminum alloy sheet to use in the above-mentioned an automobile panel and the like.

### DESCRIPTION OF EMBODIMENTS

Embodiments of the present invention are described in detail below for each requirement.

### (Chemical Component Composition)

The Al—Mg—Si aluminum alloy sheet in the present invention can have a compositional range of a 6000 series aluminum alloy in accordance with the standard of JIS or AA so long as it contains Sn and has a composition satisfying the required properties as an automobile panel for outer use such as an outer panel.

However, an aluminum alloy sheet is required to satisfy the required properties of an automobile panel as a material of an automobile panel. Specifically, it is necessary as the properties after T4 refining such as a solution treatment and a quenching treatment that the aluminum alloy sheet has low 0.2% yield strength of 110 MPa or less during forming into an automobile panel, thereby ensuring formability, and has high-strength BH responses (bake hardenability) such that 0.2% yield strength after baking hardening as an automobile panel after forming is 200 MPa or more.

Therefore, it is preferred for the aluminum alloy that this can be achieved in terms of a composition. Furthermore, other than excellent formability and BH responses, various properties such as stiffness, weldability and corrosion resistance are required as an automobile panel. Therefore, it is preferred to satisfy those requirements in terms of a composition.

As a composition of a 6000 series aluminum alloy sheet satisfying the above-described various properties required as an automobile panel, it indispensably contains, in mass % Sn: 0.005 to 0.500%, and further contains Mg: 0.20 to 1.50% and Si: 0.30 to 2.00% as main elements. The remainder of the composition is Al and unavoidable impurities. Elements other than Mg, Si and Sn are unavoidable impurities, and are contained in an amount (permissible amount) of each element level in accordance with AA or JIS standard. The % indication of the content of each element is all mass %. Furthermore, in this description, percentage (mass %) on the basis of mass is the same as percentage (wt %) on the basis of weight. Furtheimore, with respect to the content of each chemical component, the term “X% or less (excluding 0%)” may be indicated as “more than 0% and X% or less”.

The content range and significance of each element or the permissible amount in the 6000 series aluminum alloy composition are described below.

### Si: 0.30 to 2.00%

Si, along with Mg, is an indispensable element for forming an aged precipitate which contributes to the improvement of strength during an artificial aging treatment such as a baking treatment to exhibit age hardenability and providing strength (yield strength) required as an automobile panel. In a case where the amount of Si added is too small, the precipitation amount after the artificial aging becomes too small, and the increased rate of strength during baking becomes too low. On the other hand, in a case where the Si content is too large, coarse crystallized substances and precipitates are formed and become the starting point of generation of filiform rust, and filiform corrosion resistance is remarkably deteriorated. Additionally, formability such as bending workability is remarkably deteriorated. Furthermore, in a case where the Si content is too large, not only strength just after the manufacturing of a sheet, but the aged amount at room temperature after manufacturing are increased, and strength before forming becomes too high. As a result, formability into an automobile panel, particularly an automobile panel in which surface deflection becomes a problem, is deteriorated. For this reason, the Si content is in a range of 0.30 to 2.00%. The preferred lower limit of the Si content is 0.5%, and the preferred upper limit thereof is 1.5%.

In order to exhibit excellent age hardenability in a baking treatment at lower temperature for shorter period of time after forming into a panel, it is preferred to provide a 6000 series aluminum alloy composition in which Si/Mg is set to 1.0 or more in mass ratio and the content of Si with respect to Mg is more excessive than in a typically called excess-Si type.

### Mg: 0.20 to 1.50%

In addition to Si, Mg is an indispensable element for forming an aged precipitate which contributes to the improvement of strength during the artificial aging treatment such as a baking treatment to exhibit the age hardenability and providing yield strength required as an automobile panel. In a case where the Mg content is too small, the precipitation amount after the artificial aging becomes too small, and strength after baking becomes too low. On the other hand, where the Mg content is too large, an elution reaction of Mg is accelerated and filiform corrosion resistance is remarkably deteriorated. Additionally, coarse crystallized substances and precipitates are formed and become the starting point of generation of filiform rust, and this causes the deterioration of filiform corrosion resistance. Furthermore, the formation of coarse crystallized substances remarkably deteriorates formability such as bending workability, and additionally not only strength just after the manufacturing of a sheet, but the aged amount at room temperature after manufacturing are increased, and strength before forming becomes too high. As a result, formability into an automobile panel, particularly an automobile panel in which surface strain become a problem, is deteriorated. For this reason, the Mg content is in a range of 0.20 to 1.50%. The preferred lower limit of the Mg content is 0.4%, and the preferred upper limit thereof is 1.3%.

### Sn: 0.005 to 0.500%

Sn is an important indispensable element, and changes various crystallized substances acting as a cathode and becoming the starting point of the generation of filiform rust into a composition containing Sn, thereby approaching an electrochemical potential of those crystallized substances to a base metal. Thanks to this feature, electrochemical potential difference between the crystallized substances containing Sn and the surrounding aluminum becomes small, and the intermetallic compounds are difficult to act as a cathodic site and is difficult to become the starting point of filiform rust. Thus, Sn is an important element to exhibit the mechanism of improving filiform corrosion resistance. However, the effect of Sn is first exhibited in the case where the crystallized substances are precipitated as compounds with a size having a specific range as mentioned after. For this reason, the size of the crystallized substances is limited to a specific range in the present invention.

In a case where the Sn content is too small, the Sn content in the crystallized substances and the amount that changes the composition of the crystallized substances into a composition containing Sn are insufficient. As a result, the electrochemical potential of many or the greater part of the crystallized substances is maintained more noble than that of a base metal, and filiform corrosion resistance is maintained low as usual. On the other hand, in a case where the Sn content is too large, an elution reaction of Sn itself is accelerated, and filiform corrosion resistance is rather deteriorated.

Furthermore, Sn has the effect of suppressing room temperature aging of a sheet after manufacturing, thereby decreasing 0.2% yield strength during forming into an automobile member to 110 MPa or lower, and improving formability into an automobile panel in which surface deflection particularly becomes problem. Sn further has the effect of increasing 0.2% yield strength after baking hardening in terms of a composition. Sn captures (catches, traps) atomic vacancy at room temperature to suppress diffusion of Mg and Si at room temperature, and suppresses strength increase at room temperature (room temperature aging). Sn releases the captured vacancy during the artificial aging treatment such as a baking treatment of a panel after forming, and therefore rather accelerates the diffusion of Mg and Si and increases BH responses. In this regard, in a case where the Sn content is too small, Sn cannot sufficiently trap vacancy and cannot exhibit its effect, and in a case where the Sn content is too large, Sn segregates in grain boundary, likely causing the breakage of grain boundary. For the above reasons, the Sn content is in a range of 0.005 to 0.500%. The preferred lower limit of the Sn content is 0.010%, and the preferred upper limit thereof is 0.400%.

With respect to other elements, from the standpoint of resource recycle, in the case of using not only high purity Al ground metal, but a 6000 series alloy containing large amounts of elements other than Mg and Si as additional elements (alloy elements), other aluminum alloy scraps, low purity Al ground metal and the like as melting materials of an alloy, the following elements are inevitably mixed in an substantial amount. In a case where those elements are positively reduced, refining itself increases costs. Therefore, it is necessary to admit to contain those to some extent. In consequence, in the present invention, it is permitted that the following elements are each contained in a range of the upper limit or less in line with the AA to JIS standards as prescribed below, or the like.

More specifically, the aluminum alloy sheet may further contain one kind or two or more kinds selected from the group consisting of Fe: 1.0% or less (not including 0%), Mn: 1.0% or less (not including 0%), Cr: 0.3% or less (not including 0%), Zr: 0.3% or less (not including 0%), V: 0.3% or less (not including 0%), Ti: 0.05% or less (not including 0%), Cu: 1.0% or less (not including 0%), Ag: 0.2% or less (not including 0%), and Zn: 1.0% or less (not including 0%) in each of those ranges, in addition to the basic composition mentioned above.

### (Crystallized Substances)

The crystallized substances specified as a structure of a 6000 series aluminum alloy sheet of the present invention is described below.

The crystallized substances intended in the present invention is an intermetallic compound formed during casting and solidification of an aluminum alloy as conventionally known, and is generally (conventionally) an intennetallic compound having a composition of Al—Fe, Al—Fe—Mn, Al—Fe—Si, Al—Fe—Mn—Si or the like. As conventionally known, those crystallized substances mean relatively large compounds having an equivalent circle diameter of submicron meters to several ten pm. Those crystallized substances can be distinguished and be distinct from precipitates in a level of its size.

As conventionally known, the precipitate is generally a fine intermetallic compound formed from a solid phase during a heat treatment step such as homogenizing treatment, hot rolling or annealing, during room temperature aging or artificial aging. As conventionally known, a general size of the precipitate is submicron meter order that is remarkably smaller than that of the crystallized substances, and therefore can be easily distinguished (distinct) from the crystallized substances by its size, that is, the selection of magnification of a microscope used for measurement. Furthermore, those precipitates do not become a starting point of filiform rust or the like due to its small size, and do not give great influence to corrosion resistance (influence is extremely small).

On the other hand, in a case where the crystallized substances are present in the general 6000 series aluminum alloy sheet that does not contain Sn, the intermetallic compounds become electrochemical potentially more noble than the surrounding aluminum, and act as a cathodic site due to its size. Therefore, an aluminum matrix around those crystallized substances becomes the state that corrosion is very easy to proceed. Such a corrosion phenomenon appears as filiform rust (rust extended in filiform) in the state that a surface is covered with a resin coating film, like the automobile panel mentioned before.

In the present invention, the composition of the crystallized substances is changed to a composition containing Sn to decrease electrochemical potential difference to the surrounding aluminum, thereby making it difficult to act as a cathodic site and making it difficult to become the starting point of filiform rust. The existence number and existence form of the crystallized substances containing Sn are controlled as a rough standard ensuring improvement mechanism of filiform corrosion resistance and the effect.

In the structure of the 6000 series aluminum alloy sheet, the crystallized substances are Al—Fe intermetallic compound, Al—Fe—Mn intermetallic compound, Al—Fe—Si intermetallic compound or Al—Fe—Mn—Si intermetallic compound, which are formed during casting and solidification of an alloy, and mean intermetallic compounds having relatively large equivalent circle diameter of submicron meter to several ten μm.

When those crystallized substances are present in an aluminum alloy, the intermetallic compounds are electrochemical potentially more noble that the surrounding aluminum, and act as a so-called cathodic site. Therefore, an aluminum matrix around those crystallized substances (cathodic site) becomes the state that corrosion is very easy to proceed. Such a corrosion phenomenon appears as filiform rust (rust extended in filiform) in the state that a surface of an aluminum alloy sheet (panel) is covered with a resin coating film, like the automobile panel mentioned before.

In the present invention, the crystallized substances that act as the cathodic site and affect filiform corrosion resistance of a sheet, that is, the crystallized substances that should be changed to have the composition containing Sn for the improvement of filiform corrosion resistance, are specified by its size, thereby specifying as the total crystallized substances having an equivalent circle diameter in a range of 0.3 to 20 μm when measured using SEM of 500 magnifications.

Coarse crystallized substances having an equivalent circle diameter exceeding 20 μm that is the specified upper limit remarkably hinder basic mechanical properties and quality of a sheet, and additionally greatly deteriorate filiform corrosion resistance. However, in the general (conventional) manufacturing method and quality control of a sheet, the sheet is produced such that such coarse compounds are not present as possible. The present invention follows such a manufacturing method, and the coarse crystallized substances are not almost present.

On the other hand, fine crystallized substances having an equivalent circle diameter of smaller than 0.3 μm that is the specified lower limit do not become the starting point of filiform rust and the like due to its small size, similar to the fine precipitates mentioned above, and do not give great influence to filiform corrosion resistance (influence is extremely small). Furthermore, the measurement of number density and the measurement as to whether Sn is contained become difficult.

Therefore, the measurement of coarse crystallized substances having a size exceeding 20 μm that is the upper limit and fine crystallized substances having a size of smaller than 0.3 μm that is the lower limit is meaningless, and the present invention specifies that the equivalent circle diameter of the crystallized substances is in a range of 0.3 to 20 μm.

The equivalent circle diameter of a compound defined in the present invention is a diameter of a circle having the same area as that of an amorphous compound, and is conventionally used as a method of measuring or specifying a size of a crystallized substance precisely with good reproducibility.

### (Crystallized Substances Containing Sn)

In a structure of a 6000 series aluminum alloy sheet, Sn added enters crystallized substances under certain manufacturing conditions, and then, the crystallized substances have a composition containing Sn, thereby being difficult to become the starting point of filiform rust. For this reason, the present invention specifies the number of crystallized substances changed to a composition containing Sn (average number density) in crystallized substances having a certain size and the proportion of the number to the average number of all crystallized substances having a certain size (average number density).

That is, in all crystallized substances having the equivalent circle diameter in a range of 0.3 to 20 μm, the average number density of crystallized substances containing Sn identified by X-ray spectrometer is set to a range of 10 numbers/mm² to 2000 numbers/mm², and additionally the proportion of the average number density of the crystallized substances containing Sn to the average number density of all crystallized substances having the equivalent circle diameter in a range of 0.3 to 20 μm is set to 70% or more.

The crystallized substances containing Sn intended in the present invention are crystallized substances identified as containing Sn exceeding the detection limit in X-ray spectrometer. When the crystallized substances having the equivalent circle diameter in a range of 0.3 to 20 μm that act as the cathodic site and should be made to have a composition containing Sn for the improvement of filiform corrosion resistance of a sheet have a composition containing Sn, the electrochemical potential difference to the surrounding aluminum becomes small, and as a result, the crystallized substances are difficult to act as a cathodic site and are difficult to become the starting point of filiform rust.

The mechanism of improving filiform corrosion resistance in the present invention has a great property that the improvement of filiform corrosion resistance is possible without decreasing the number of crystallized substances necessary for ensuring mechanical properties such as strength of an aluminum alloy sheet. For this reason, in the present invention, filiform corrosion resistance can be improved without deteriorating mechanical properties such as strength of an Al—Mg—Si aluminum alloy sheet, and the application of the Al—Mg—Si aluminum alloy sheet to the above-mentioned automobile panel is possible or can be accelerated.

For the improvement of filiform corrosion resistance, it is preferred that many number and proportion as possible of crystallized substances having the equivalent circle diameter in a range of 0.3 to 20 μm, present in a 6000 series aluminum alloy sheet, are made to have a composition containing Sn. In a case where the number and proportion of crystallized substances having a composition that does not contain Sn are increased, the mechanism and effect of the improvement of filiform corrosion resistance cannot be ensured.

Therefore, in the present invention, in order to ensure the improvement of filiform corrosion resistance, the average number density of the crystallized substances containing Sn is set to 10 numbers/mm² or more, and the proportion of the average number density of the crystallized substances containing Sn to the average number density of all crystallized substances having the equivalent circle diameter in a range of 0.3 to 20 μm is set to 70% or more. The average number density of all crystallized substances having the equivalent circle diameter in a range of 0.3 to 20 μm used herein is the total of the average number density of crystallized substances that do not contain Sn and the average number density of crystallized substances containing Sn.

However, in a case where the amount of the crystallized substances having a composition containing Sn is too large, even though the electrochemical potential difference to the surrounding aluminum is decreased, the crystallized substances become a cathodic site and the absolute number of crystallized substances capable of becoming the starting point of filiform rust is increased. As a result, filiform corrosion resistance is rather deteriorated. Furthermore, from the limit on manufacturing, it is difficult to contain Sn in all of crystallized substances, and crystallized substances having a composition that does not contain Sn are generally present. Furthermore, a permissible amount (number) of crystallized substances having a composition that does not contain Sn, that do not hinder the improvement of filiform corrosion resistance, is also present.

Therefore, the present invention specifies that the upper limit of the average number density of the crystallized substances containing Sn is 2000 numbers/mm².

The upper limit of the proportion of the average number density of the crystallized substances containing Sn to the average number density of all crystallized substances having the equivalent circle diameter in a range of 0.3 to 20 μm is not particularly limited, but is about 95% from the limit on manufacturing.

When the number (average number density) of the crystallized substances themselves having an equivalent circle diameter of 0.3 μm or more is decreased even though the crystallized substances do not contain Sn unlike the present invention, corrosion resistance of a material is greatly improved. However, the decrease of the number of crystallized substances leads to the deterioration of strength of a material. Therefore, the prior art had the great limit that crystallized substances must be present in the certain number or more for preventing the deterioration of strength, and filiform corrosion resistance cannot be further improved.

On the other hand, if filiform corrosion resistance can be improved by containing Sn in crystallized substances to change a composition of the crystallized substances as in the present invention, the effects of both strength and filiform corrosion resistance that are contradictory can be achieved without decreasing the number of crystallized substances. That is, the mechanism of the improvement of filiform corrosion resistance of the present invention has the characteristic that the improvement of filiform corrosion resistance is possible without decreasing the number of crystallized substances necessary for ensuring mechanical properties such as strength of a sheet. As a result, in the present invention, filiform corrosion resistance can be improved without deteriorating mechanical properties such as strength of an Al—Mg—Si aluminum alloy sheet, the application of an Al—Mg—Si aluminum alloy sheet to an automobile panel and the like becomes possible or can be accelerated.

### (Measurement of Crystallized Substances)

The measurement of number density of all crystallized substances having an equivalent circle diameter in a range of 0.3 to 20 μm by SEM of 500 magnifications is performed on optional spots (10 places) at the portion of ¼ in a sheet thickness direction from a surface of a test sheet (10 samples are collected), and the respective number densities of those samples are averaged to obtain an average number density (numbers/mm²). The measurement of the proportion of the number of compounds containing Sn mentioned after is performed according to this measurement by SEM, and the respective proportions of the number of the samples are similarly averaged to obtain an average proportion (%) of the number. Specifically, regarding a cross-section perpendicular to a sheet thickness direction of a test sheet just after a refining treatment, a face passing through an optional spot at the portion of ¼ in a sheet thickness direction from the surface and parallel to a sheet surface is measured using SEM (Scanning Electron Microscope) of 500 magnifications.

The surface of each of 10 sheet cross-sectional samples sampled from the above site is mechanically polished, the portion having a depth of about 0.25 mm from the sheet surface is scraped off by mechanical polishing, and buffing is further performed. Thus, a sample having a surface adjusted is prepared.

Next, the number of compounds having an equivalent diameter in the range mentioned above is measured by an automated analyzer utilizing a backscattered electron image, and the number density is calculated. The measurement site is a polished surface of a sample, and a measurement region per one sample is 240 μm×180 μm.

X-ray spectrometer used in the measurement of the proportion of the number of crystallized substances containing Sn is conventionally known as a spectrometer by energy dispersive X-ray spectroscopy, and is generally called EDX.

This X-ray spectrometer is generally attached to SEM used in the present invention, and is widely used in quantitative analysis of, for example, a composition of an crystallized substances to be observed, by a method of detecting characteristic X-ray generated by electron beam irradiation and performing elemental analysis and compositional analysis by diffracting with energy.

By the X-ray spectrometer, of total crystallized substances having the equivalent circle diameter measured by the SEM in a range of 0.3 to 20 μm (in total numbers), the number of crystallized substances identified as containing Sn in an amount of the detection limit or more by the X-ray spectrometer is measured, the measurement results of 10 samples are averaged, and an average number density is calculated.

Furthermore, the proportion (%) of the average number density of the crystallized substances containing Sn to the average number density of all crystallized substances having an equivalent circle diameter in a range of 0.3 to 20 μm (the total of the average number density of crystallized substances that do not contain Sn and the average number density of crystallized substances containing Sn) is calculated.

### (Manufacturing Method)

Next, a method of manufacturing the aluminum alloy sheet in the present invention is described below. The manufacturing method of the aluminum alloy sheet in the present invention is a normally practiced or conventional method. The aluminum alloy sheet in the present invention is manufactured by casting an ingot of an aluminum alloy having the 6000 series component composition shown above, performing a homogenizing heat treatment to the ingot, performing hot rolling and cold rolling thereto to provide an aluminum alloy sheet with a predetermined thickness, and further performing a temper treatment such as a solution and quenching treatment thereto.

### Melting and Casting Cooling Rate:

First, in a melting and casting step, a molten metal of an aluminum alloy which has been modified by melting so as to fall within the 6000 series component composition range shown above is solidified by cooling the molten metal with water in succession by a DC casting (semi-continuous casting method) using a water-cooling type cast having opened upper and lower parts, thereby producing an ingot (slab).

In order to set the average number density of the crystallized substances containing Sn to a range of 10 numbers/mm² to 2000 numbers/mm² in all crystallized substances having an equivalent circle diameter in a range of 0.3 to 20 μm, as specified in the present invention, it is preferred to maximize (make as high as possible) an average cooling rate during casting by performing cooling from a liquidus temperature to a solidus temperature at a rate of 40° C./min or more and from a solidus temperature to 400° C. at a rate of 40° C./min or more.

The cooling rate is naturally influenced by a size and thickness of an ingot in the case of casting an ingot (slab) by the DC casting. Therefore, it is preferred that the cooling rate is applied as a range of a widely used and general casting rate of an ingot.

If such temperature control in a high temperature region during casting, that is, control of a cooling rate, is not performed, the cooling rate of an ingot in this high temperature region inevitably decreases. When the cooling rate in the high temperature region is thus decreased, an amount of crystallized substances coarsely produced in the temperature range of the high temperature region increases. For this reason, variations in the size and amount of the crystallized substances in the sheet width direction and thickness direction of the ingot increases. As a result, the possibility that the average number density of the crystallized substances containing Sn cannot be controlled within the specified range of the present invention is high.

### Homogenizing Heat Treatment:

Then, prior to hot rolling, the homogenizing heat treatment of the cast aluminum alloy ingot mentioned above is performed. The homogenizing heat treatment (soaking) aims at homogenizing a structure, i.e., eliminating segregation in grains in the structure of the ingot. The homogenizing heat treatment is not particularly limited as long as the aim is achieved, and the homogenizing heat treatment may be performed one time or one stage treatment as in general cases. The temperature of the homogenizing heat treatment is appropriately selected from a range of 500° C. or higher and lower than a melting point, and a homogenizing period is appropriately selected from a range of 4 hours or more. Thereafter, hot rolling may be performed immediately, or hot rolling may be performed after cooling to an appropriate temperature and maintaining at the temperature.

Hot Rolling:

Depending on the thickness of a sheet to be rolled, the hot rolling process includes a rough rolling step for the ingot (slab) and a finish rolling step. In those rough rolling step and finish rolling step, a rolling mill of a reverse type, a tandem type or the like is appropriately used.

### Annealing of Hot-Rolled Sheet:

The annealing (pre-annealing) prior to the cold rolling of the hot-rolled sheet is not necessarily needed, but may be performed for further improving properties such as corrosion resistance by refinement of grains and adjustment of textures.

### Cold Rolling:

In the cold rolling, the hot-rolled sheet mentioned above is rolled to form into a cold-rolled sheet (including a coil) having a desired final thickness. In order to obtain finer grains, it is desirable that the total cold rolling reduction is 60% or more, regardless of the number of passes.

### Solution and Quenching Treatments:

After the cold rolling, solution and quenching treatment is performed. The solution treatment and quenching treatment is performed by heating and cooling by general continuous heat treatment line, and is not particularly limited. The quenching treatment may be performed by selecting air quenching using a fan or the like, a water quenching means such as mist, spraying, immersion or the like, and conditions.

The present invention will be described below more specifically by way to examples. However, the following examples are not intended to limit the present invention and may be implemented by making appropriate modifications within the scope conformable to the gist described above and below, and these modifications are all included in the technical scope of the present invention.

### EXAMPLES

Next, the examples of the present invention will be described. 6000 Series aluminum alloy sheets having different existence state of crystallized substances were separately prepared, and mechanical properties and filiform corrosion resistance were investigated and evaluated.

### (Manufacturing Conditions of Sheet)

Specifically, 6000 series aluminum alloy ingots having each composition shown in Table 1 were produced by a DC casting method, followed by cooling by variously changing an average cooling rate during casting in a range of a liquidus temperature to a solidus temperature and in a range of a solidus temperature to 400° C. as shown in Table 2, thereby controlling a composition and existence state of crystallized substances. In the indication of the content of each element in Table 1, the indication in which the numerical value in each element is blank means that the content is lower than the defection limit, and is 0% that does not contain those elements.

In each of the examples, those ingots were subjected to soaking at 540° C. for 6 hours, and rough hot rolling was initiated at the temperature. The ingots were hot-rolled to have a thickness of 2.5 mm by the subsequent finish rolling to form hot rolled sheets. The hot rolled sheets were subjected to process annealing at 500° C. for 1 minute, followed by subjecting to cold rolling in a working ratio of 60% without being subjected to intermediate annealing between cold rolling passes, thereby obtaining cold rolled sheets having a thickness of 1.0 mm.

In each of the examples, each of those cold-rolled sheets was further subjected to a solution treatment in a salt bath at 560° C. and maintained for 10 seconds after reaching a target temperature, followed by subjecting to a water quenching. Test sheets (blanks) were cut out of the sheets after the quenching treatment (just after the production), the structure (average number density of all crystallized substances and average number density of crystallized substances containing Sn) just after the quenching treatment (sheet manufacturing) of each test sheet was measured.

The measurement was performed by the measurement method mentioned before. That is, the average number density (numbers/mm²) of all crystallized substances having an equivalent circle diameter in a range of 0.3 to 20 μm was measured by SEM of 500 magnifications. Furthermore, of those all crystallized substances, the average number density (numbers/mm²) of the crystallized substances containing Sn identified by X-ray spectrometer was measured. The proportion (%) of the average number density of the crystallized substances containing Sn to the average number density of all crystallized substances having an equivalent circle diameter in a range of 0.3 to 20 μm was measured.

Of all crystallized substances having an equivalent circle diameter in a range of 0.3 to 20 μm, an average number density (numbers/mm) of crystallized substances that do not contain Sn and that of crystallized substances containing Sn are shown in Table 2. The proportion (%) of the average number density of the crystallized substances containing Sn to the average number density of all crystallized substances having an equivalent circle diameter in a range of 0.3 to 20 μm is also shown. In Table 2, the average number density of all crystallized substances having the above-mentioned equivalent circle diameter is the total of the average number density of crystallized substances that do not contain Sn and the average number density of crystallized substances containing Sn.

Furthermore, considering that the sheet thus manufactured would be aged at room temperature before being formed into an automobile outer panel, a test piece having a length of 100 mm and a width of 25 mm was collected from each test sheet after allowing to stand at room temperature (room temperature aging) for 30 days after manufacturing (after a quenching treatment). As mechanical properties of each test piece aged at room temperature, 0.2% yield strength (As yield strength) was obtained by a tensile test. Furthermore, in each of those test sheets, 0.2% yield strength (yield strength after BH) of the test sheet after aging at room temperature for 30 days and then subjecting it to an artificial age hardening treatment at 185° C. for 20 minutes (i.e. after the BH) was obtained by a tensile test. BH responses of each test sheet (test piece) were evaluated from the difference (increased amount of yield strength) between those 0.2% yield strengths.

### (Tensile Properties)

As the tensile test, each No. 5 test specimen (having a size of 25 mm×50 mm as GL×Thickness) in accordance with JIS Z 220 was collected from each test sheet aged at room temperature, followed by subjecting to a tensile test at room temperature. In this case, a tensile direction of the test specimen was a direction perpendicular to a rolling direction. A tensile rate was 5 min/min until reaching 0.2% yield strength, and was 20 mm/min after reaching the yield strength. The number N of the measurement of mechanical properties was set to 5, and average value was calculated for each of the properties. Prestrain of 2% simulating press forming of a sheet was given to the test specimen for the measurement of yield strength after the BH by the tensile tester, and the BH treatment was then performed.

### (Hem Workability)

Hem workability was evaluated. A strip specimen having a width of 30 mm was used as each test sheet aged at room temperature. After performing 90° bending working of inner bending R=1.0 mm by down flange, an inner having a thickness of 1.0 mm was interposed. Preliminary hem working that further bends the bent part inside to an angle of about 130° and flat hem working that bends 180° to closely contact the edge with the inner were performed.

Surface state such as generation of surface roughness, fine cracking or large cracking of the bent part (hemming part) of the flat hem was visually observed and was visually evaluated by the following standards. In the following standards, 0 to 2 are acceptable, and 3 or less are unacceptable.

0: No cracking and surface roughness

1: Slight surface roughness

2: Deep surface roughness

3: Fine surface cracking

4: Linearly continuous surface cracking

5: Breakage

### (Corrosion Test of Test Sheet)

Filiform corrosion resistance of each test sheet aged at room temperature was evaluated. The evaluation was performed as follow. A sheet of 80×150 mm was cut out of each test sheet aged at room temperature, and dipped in a sodium carbonate degreasing bath at 40° C. for 2 minutes (with stirring with a stirrer) to subject a surface of the test sheet to a degreasing treatment. Next, the test sheet was dipped in a zinc surface conditioning bath at room temperature for 1 minute (with stirring with a stirrer), and then dipped in a 35° C. zinc phosphate bath for 2 minutes to perform a zinc phosphate treatment. Electrodeposition coating (thickness 20 μm) was performed in accordance with the general painting step of an automobile member, and a baking treatment was then performed at 185° C. for 20 minutes. Thereafter, cross-cut scratches having a length of 50 mm were formed on the coating film, a cycle of “salt water spraying 24 hours wetting (humidity 85%, 40° C.) 120 hours→natural drying (room temperature) 24 hours” was performed 8 times, and a width of rust at one side of a cross-cut portion was measured (filiform corrosion resistance).

The filiform corrosion resistance was evaluated by maximum filiform rust length. A test sheet having the maximum filiform rust length of less than 1 mm was evaluated as “0”, a test sheet having the maximum filiform rust length of 1 mm or more and less than 2 mm was evaluated as “0”, a test sheet having the maximum filiform rust length of 2 mm or more and less than 3 mm was evaluated as “Δ”, and a test sheet having the maximum filiform rust length of 3 mm or more was evaluated as “×”. Test sheets having the results of “⊚” and “◯” were judged as materials having excellent filiform corrosion resistance (acceptable)

### (Test Results)

Each of Invention examples had an alloy composition containing Sn within the specified range as shown in Table 1, and was manufactured within the range of the above-mentioned preferred cooling rate during casting as shown in Table 2, and an average number density of the crystallized substances containing Sn and the proportion of the average number density to an average number density of total crystallized substances having an equivalent circle diameter in a range of 0.3 to 20 μm are controlled within the range specified in the present invention. Therefore, each of Invention Examples is excellent in filiform corrosion resistance.

Furthermore, in each of Invention Examples, the improvement effect of filiform corrosion resistance is achieved without deteriorating formability and mechanical properties. That is, each of Invention Examples is the case after room temperature aging after the refining treatment, and is excellent in BH responses. Furthermore, even after room temperature aging after the refining treatment. As yield strength is relatively low. Therefore, press formability to an automobile panel or the like is excellent, and hem workability is also excellent. Therefore, each of Invention Examples satisfies each of the required properties as an outer panel for an automobile.

In contrast, in each of Comparative Examples, the sheets were manufactured under the conditions deviated from the range of the above-mentioned preferred cooling rate during casting as shown in Table 2 even though the alloy composition is out of the specified range or the alloy composition is within the specified range as shown in Table 1, and the average number density of the crystallized substances containing Sn is out of the range specified in the present invention. Therefore, filiform corrosion resistance is far inferior to that of Invention Examples or formability and mechanical properties do not satisfy the required properties as an outer panel for an automobile, and it cannot be used as an outer panel for an automobile.

In Comparative Examples 19 to 24, Alloy Nos. 1 and 2 within the composition range of the present invention shown in Table 1 were used, but the cooling rate during ingot casting is too late in the range of from a liquidus temperature to a solidus temperature, or the range of from a solidus temperature to 400° C. For this reason, the average number density of the crystallized substances containing Sn and the proportion of it to the average number density of total crystallized substances is too small or too large, and particularly filiform corrosion resistance is far inferior to that of Invention Examples.

In Comparative Examples 25 and 26, the contents of Mg and Si are too low (Alloy Nos. 19 and 20 in Table 1), and even though the manufacturing method and the number density of crystallized substances satisfy the requirements and good results were obtained in filiform corrosion resistance, but strength including As and after BH is too low.

In Comparative Examples 27 to 29, the contents Mg and Si and the content of Sn are too large as in Alloy Nos. 21 to 23 in Table 1. For this reason, despite that those were manufactured within the preferred ranges including the cooling rate during ingot casting, the proportion of the average number density of the crystallized substances containing Sn to the average number density of total crystallized substances is small, and particularly filiform corrosion resistance is far inferior to that of Invention Examples.

In Comparative Example 30, Sn is not contained as in Alloy No. 24 in Table 1. For this reason, as a matter of course, crystallized substances containing Sn are not present. However, in a fast cooling rate during ingot casting that is preferred in the case of containing Sn, the amount of crystallized substances that do not contain Sn and become a cathode decreases. As a result, Comparative Example 30 is excellent in filiform corrosion resistance, but strength is too low and formability is poor. Therefore, the sheet of Comparative Example 30 does not satisfy the required characteristic as an outer panel for an automobile, and cannot be used as an outer panel for an automobile.

In Comparative Example 31, Sn content is too small as in Alloy No. 25 in Table 1. For this reason, despite that the sheet was manufactured within the preferred ranges of the conditions including the cooling rate during ingot casting, the crystallized substances containing Sn are not substantially present as compared with the crystallized substances that do not contain Sn and become a cathode, and particularly filiform corrosion resistance is far inferior to that of Invention Examples.

In Comparative Example 32, Sn is not contained as in Alloy No. 24 in Table 1. The cooling rate is not fast cooling rate during ingot casting that is preferred in the case of containing Sn, but is relatively slow cooling rate as conventionally used. For this reason, the amount of the crystallized substances that do not contain Sn and become a cathode increases, and filiform corrosion resistance is markedly poor. Therefore, the sheet of Comparative Example 32 cannot be used as an outer panel for an automobile.

The significance of action and effect is supported by the results of the above examples that the improvement effect in filiform corrosion resistance in the crystallized substances containing Sn as specified in the present invention can be achieved without deteriorating formability and mechanical properties.

TABLE 1

| | Chemical components of aluminum alloy sheet | | | | | | | | | | | |
|---|---|---|---|---|---|---|---|---|---|---|---|---|
| Alloy | (mass %, remainder Al) | | | | | | | | | | | |
| No. | Mg | Si | Sn | Fe | Mn | Cr | Zr | V | Ti | Cu | Zn | Ag |
| 1 | 0.55 | 0.95 | 0.050 | | | | | | | | | |
| 2 | 0.55 | 0.95 | 0.050 | 0.2 | | | | | | | | |
| 3 | 1.18 | 1.00 | 0.050 | 0.2 | | | | | | | | |
| 4 | 0.60 | 1.35 | 0.050 | 0.2 | | | | | | | | |
| 5 | 0.55 | 0.90 | 0.012 | 0.2 | | | | | | | | |
| 6 | 0.55 | 0.90 | 0.370 | 0.2 | | | | | | | | |
| 7 | 0.55 | 0.90 | 0.040 | 0.7 | | | | | | | | |
| 8 | 0.55 | 0.90 | 0.040 | 0.2 | 0.12 | | | | | | | |
| 9 | 0.55 | 0.90 | 0.060 | 0.2 | | 0.05 | | | | | | |
| 10 | 0.55 | 0.90 | 0.080 | 0.2 | | | 0.05 | | | | | |
| 11 | 0.55 | 0.90 | 0.070 | 0.2 | | | | 0.05 | | | | |
| 12 | 0.55 | 0.90 | 0.050 | 0.2 | | | | | 0.50 | | | |
| 13 | 0.55 | 0.90 | 0.050 | 0.2 | | | | 0.22 | 0.01 | | | |
| 14 | 0.55 | 0.90 | 0.050 | 0.2 | 0.12 | | | | | 0.30 | | |
| 15 | 0.55 | 0.90 | 0.060 | 0.2 | | | | | | 0.80 | | |
| 16 | 0.55 | 0.90 | 0.050 | 0.2 | | | | | | | 0.05 | |
| 17 | 0.55 | 0.90 | 0.060 | 0.2 | | | | | | | 1.10 | |
| 18 | 0.50 | 0.95 | 0.050 | 0.2 | | | | | | 0.15 | | 0.01 |
| 19 | 0.18 | 0.95 | 0.050 | 0.2 | | | | | | | | |
| 20 | 0.55 | 0.27 | 0.050 | 0.2 | | | | | | | | |
| 21 | 1.60 | 0.95 | 0.050 | 0.2 | | | | | | | | |
| 22 | 0.40 | 2.10 | 0.050 | 0.2 | | | | | | | | |
| 23 | 0.55 | 0.90 | 0.560 | 0.2 | | | | | | | | |
| 24 | 0.55 | 0.90 | | 0.2 | | | | | | | | |
| 25 | 0.55 | 0.90 | 0.004 | 0.2 | | | | | | | | |

TABLE 2

| | | | | | Crystallized substances of Al—Mg—Si alloy | | | | | | | |
|---|---|---|---|---|---|---|---|---|---|---|---|---|
| | | | | | sheet just after manufacturing (Equivalent | | | | | | | |
| | | | | | circle diameter is a range of from 0.3 to 20 μm) | | | | | | | |
| | | | Cooling rate during | | | | Average number | Properties of Al—Mg—Si alloy sheet after | | | | |
| | | | ingot casting | | Average | Average | density of Sn- | maintaining at room temperature for 30 days | | | | |
| | | | From | From | number | number | containing | | 0.2% | | | |
| | | Alloy | liquidus | solidus | density of | density of | crystallized | As | yield | Increased | | |
| | | No. | temperature | temper- | crystallized | crystallized | substances/average | 0.2% | strength | amount | Hem | |
| | | in | to solidus | ature to | substances not | substances | number density of | yield | after | of yield | work- | Filiform |
| Cate- | | Table | temperature | 400° C. | containing Sn | containing Sn | all crystallized | strength | BH | strength | a- | corrosion |
| gory | No. | 1 | ° C./min | ° C./min | Numbers/mm² | Numbers/mm² | substances | MPa | MPa | MPa | bility | resistance |
| Inven- | 1 | 1 | 45 | 45 | 151 | 841 | 0.85 | 93 | 213 | 120 | 0 | [symbol] |
| tion | 2 | 2 | 42 | 43 | 159 | 755 | 0.83 | 87 | 228 | 141 | 0 | [symbol] |
| Exam- | 3 | 3 | 46 | 47 | 178 | 523 | 0.75 | 88 | 218 | 130 | 2 | ○ |
| ples | 4 | 4 | 45 | 44 | 187 | 584 | 0.76 | 101 | 241 | 140 | 0 | ○ |
| | 5 | 5 | 45 | 48 | 263 | 751 | 0.74 | 107 | 217 | 110 | 1 | ○ |
| | 6 | 6 | 44 | 42 | 308 | 992 | 0.76 | 99 | 230 | 131 | 1 | ○ |
| | 7 | 7 | 45 | 46 | 256 | 883 | 0.78 | 101 | 226 | 125 | 1 | ○ |
| | 8 | 8 | 45 | 45 | 200 | 741 | 0.79 | 98 | 219 | 121 | 0 | ○ |
| | 9 | 9 | 42 | 42 | 76 | 760 | 0.91 | 98 | 221 | 123 | 0 | [symbol] |
| | 10 | 10 | 48 | 45 | 213 | 687 | 0.76 | 91 | 219 | 128 | 0 | ○ |
| | 11 | 11 | 45 | 45 | 152 | 584 | 0.79 | 107 | 226 | 119 | 1 | ○ |
| | 12 | 12 | 45 | 46 | 150 | 997 | 0.87 | 100 | 237 | 137 | 0 | [symbol] |
| | 13 | 13 | 45 | 47 | 154 | 562 | 0.78 | 97 | 245 | 148 | 2 | ○ |
| | 14 | 14 | 45 | 45 | 154 | 512 | 0.77 | 91 | 217 | 126 | 1 | ○ |
| | 15 | 15 | 45 | 43 | 190 | 702 | 0.79 | 89 | 259 | 170 | 0 | ○ |
| | 16 | 16 | 43 | 45 | 234 | 730 | 0.76 | 90 | 223 | 133 | 1 | ○ |
| | 17 | 17 | 48 | 45 | 222 | 716 | 0.76 | 101 | 231 | 130 | 0 | ○ |
| | 18 | 18 | 45 | 45 | 195 | 650 | 0.77 | 103 | 211 | 108 | 0 | ○ |
| Com- | 19 | 1 | 35 | 31 | 1937 | 8 | 0.00 | 102 | 205 | 103 | 0 | × |
| par- | 20 | 1 | 32 | 41 | 1930 | 3128 | 0.62 | 87 | 213 | 126 | 2 | Δ |
| ative | 21 | 1 | 45 | 37 | 841 | 5 | 0.01 | 96 | 221 | 125 | 1 | × |
| Exam- | 22 | 2 | 33 | 35 | 1272 | 2231 | 0.64 | 95 | 219 | 124 | 1 | Δ |
| ples | 23 | 2 | 36 | 43 | 1891 | 2081 | 0.52 | 104 | 217 | 113 | 0 | × |
| | 24 | 2 | 45 | 35 | 1203 | 6 | 0.00 | 102 | 219 | 117 | 0 | × |
| | 25 | 19 | 45 | 44 | 195 | 549 | 0.74 | 53 | 118 | 65 | 3 | ○ |
| | 26 | 20 | 43 | 44 | 221 | 558 | 0.72 | 48 | 134 | 86 | 3 | ○ |
| | 27 | 21 | 45 | 42 | 301 | 684 | 0.69 | 102 | 235 | 133 | 4 | Δ |
| | 28 | 22 | 47 | 46 | 410 | 594 | 0.59 | 90 | 214 | 124 | 4 | × |
| | 29 | 23 | 44 | 45 | 355 | 623 | 0.64 | 89 | 224 | 135 | 3 | Δ |
| | 30 | 24 | 46 | 43 | 163 | 0 | 0.00 | 78 | 174 | 96 | 5 | [symbol] |
| | 31 | 25 | 45 | 45 | 823 | 1 | 0.00 | 99 | 227 | 128 | 4 | × |
| | 32 | 24 | 35 | 34 | 1312 | 0 | 0.00 | 100 | 214 | 114 | 1 | × |

Although the present invention has been described in detail and by reference to the specific embodiments, it is apparent to one skilled in the art that various modifications or changes can be made without departing the spirit and scope of the present invention.

This application is based on Japanese Patent Application No. 2014-173276 filed on Aug. 27, 2014, the disclosure of which is incorporated herein by reference in its entity.

### INDUSTRIAL APPLICABILITY

According to the present invention, a 6000 series aluminum alloy sheet that can improve filiform corrosion resistance can be provided without inhibiting BH responses and formability after room temperature aging. As a result, the 6000 series aluminum alloy sheet can be widely applied to a panel for an automobile, particularly a panel for outer use such as an outer panel in which designability such as beautiful curved surface configuration or character line becomes a problem.

1. An Al—Mg—Si aluminum alloy sheet comprising: in mass %,
Mg: 0.20 to 1.50%;
Si: 0.30 to 2.00%; and
Sn: 0.005 to 0.500%;
with the remainder being Al and unavoidable impurities,
wherein, as a structure of the aluminum alloy sheet, in all crystallized substances having an equivalent circle diameter of 0.3 to 20 μm when measured with SEM of 500 magnifications, an average number density of crystallized substances containing Sn identified by an X-ray spectrometer is 10 numbers/mm² to 2000 numbers/mm², and a proportion of the average number density of the crystallized substances containing Sn to an average number density of all crystallized substances having the equivalent circle diameter of 0.3 to 20 μm is 70% or more.

2. The aluminum alloy sheet according to claim 1, further comprising: in mass %, one kind or two or more kinds selected from the group consisting of Mn: more than 0% and 1.0% or less, Cu: more than 0% and 1.0% or less, Fe: more than 0% and 1.0% or less, Cr: more than 0% and 0.3% or less, Zr: more than 0% and 0.3% or less, V: more than 0% and 0.3% or less, Ti: more than 0% and 0.05% or less, Zn: more than 0% and 1.0% or less and Ag: more than 0% and 0.2% or less.
